(19) United States
(12) Patent Application Publication
(10) Pub. No.: US 2009/0189860 A1
(43) Pub. Date: Jul. 30, 2009

(54) METHOD FOR REDUCING POWER CONSUMPTION OF WIRELESS MOUSE

(75) Inventors: Chun-Nan Su, Taipei (TW); Chin-Lung Lai, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/131,586

(22) Filed: Jun. 2, 2008

(30) Foreign Application Priority Data
Jan. 25, 2008 (TW) 097102771

(51) Int. Cl. G08C 17/00; G06F 3/033

(52) U.S. Cl. 345/163; 370/311

(57) ABSTRACT

The present invention provides a method for reducing power consumption of a wireless mouse. At least two sets of mouse moving data are combined into a single packet to be transmitted to a wireless signal receiver. In the wireless signal receiver side, the single packet is divided into the at least two sets of mouse moving data. Since the frequency of transmitting these mouse moving data is reduced, the power consumption of operating the wireless mouse is reduced.

### FIELD OF THE INVENTION

The present invention relates to a method for reducing power consumption of a wireless mouse, and more particularly to a method for reducing power consumption of a wireless mouse by changing time interval of data transmission of the wireless mouse.

### BACKGROUND OF THE INVENTION

With rapid development of electronic and information industries, computers and the peripheral device thereof become essential parts in our daily lives. For example, mice are important peripheral devices of computers for establishing contact between the personal computers and the users. For helping the user well operate the computer, many novel mice (e.g. wireless mice) with expanded functions are developed in views of humanization and user-friendliness.

Conventionally, a mouse is communicated with a computer via wire linkage. The wire linkage is very troublesome and inconvenient. Instead of using the connecting wire, a corresponding wireless signal receiver is used for receiving wireless signals issued from the mouse body when the wireless mouse is operated. Since no additional connecting wire is required to connect the wireless mouse with the computer, the use of the wireless mouse is more convenient. In addition to the wireless mouse, other wireless peripheral devices such as wireless earphones, wireless keyboards and the like are communicated with the computer according to a wireless transmission technology. Among these wireless peripheral devices, the wireless mouse is very popular.

Although the wireless mouse is convenient because no signal wire is required, there are still some several drawbacks. For example, when the wireless mouse is operated, a battery is required to provide electricity because no power can be supplied to the wireless mouse through a connecting port of the computer. Therefore, it is critical to extend the use time of the battery by reducing power consumption of the wireless mouse.

FIG. 1 is a schematic diagram illustrating wireless communication of a conventional wireless mouse. The wireless mouse 100 principally comprises a wireless signal emitter 101 and a control unit 102. The wireless signal emitter 101 can emit a wireless signal WS. A wireless signal receiver 103 is plugged into a universal serial bus (USB) port of the computer system 104 for receiving the wireless signal WS. In response to a triggering operation of for example pressing down a click button, rotating the scroll wheel, horizontally moving the wireless mouse, vertically moving the wireless mouse and the like, the wireless mouse 100 will generate a corresponding mouse moving data. Under control of the control unit 102, the mouse moving data is converted into a moving data packet. Next, the wireless signal WS containing the moving data packet is transmitted from the wireless signal emitter 101 to the wireless signal receiver 103. After receiving the wireless signal WS, the wireless signal receiver 103 transmits the moving data packet to the computer system 104. By reading the mouse moving data, the computer system can execute a function corresponding to the triggering operation of the wireless mouse 100.

For each triggering operation of the wireless mouse, the wireless mouse will generate a set of mouse moving data. The user may input an instruction to control the computer system by the wireless mouse when the mouse moving data corresponding to the instruction is transmitted to the computer system. As a consequence, the computer will execute the instruction. The mouse moving data include for example horizontal mouse moving data, vertical mouse moving data, key clicking data, scroll wheel rotating data and window horizontal scrolling data. During wireless transmission, the mouse moving data are readily subject to interference from external noise such that damaged or erroneous data occur. For protecting data from being interfered by noise, the mouse moving data should be converted into moving data packets during wireless transmission. A moving data packet includes for example a pilot code, a device ID code, a flag, a payload data and a cyclic redundancy check (CRC) code. According to the pilot code, the transmission of the moving data packet is synchronous with the wireless signal. According to the device ID code, the signal receiving terminal can recognize whether the packet is transmitted from a corresponding signal output terminal. The flag indicates a current state of wireless transmission. According to the CRC code, the damaged or erroneous data resulted from external noise during wireless transmission are discriminated and thus the signal output terminal reissues a signal. The payload data includes a data type code and the mouse moving data.

FIG. 2A is a schematic timing waveform diagram illustrating related moving data packets transmitted from the wireless signal emitter of the conventional wireless mouse to the wireless signal receiver. As shown in FIG. 2A, four successive sets of moving data packets are generated in response to triggering operations by the use. These moving data packets includes a first moving data packet 11, a second moving data packet 12, a third moving data packet 13 and a fourth moving data packet 14. The data formats of these moving data packets are substantially identical except for the contents of the mouse moving data. For clarification, only the data format of the first moving data packet 11 is illustrated. The first moving data packet 11 includes a first pilot code 111, a first device ID code 112, a first flag 113, a first payload data 114 and a first CRC code 115. The first payload data 114 includes a first data type code DI11 and first mouse moving data 1141. The first mouse moving data 1141 includes a first key clicking data Key11, a first horizontal mouse moving data X11, a first vertical mouse moving data Y11, a first scroll wheel rotating data Z11 and a first window horizontal scrolling data H11.

FIG. 2B is a schematic timing waveform diagram illustrating related mouse moving data transmitted from the wireless signal receiver to the computer system. Hereinafter, the procedure of data transmission will be illustrated with reference to FIG. 1, FIG. 2A and FIG. 2B.

In response to a triggering operation by the wireless mouse 100, the wireless mouse 100 will generate a corresponding first mouse moving data 1141. Under control of the control unit 102, the first mouse moving data 1141 is converted into a first moving data packet 11. Next, a wireless signal WS containing the first moving data packet 1141 is transmitted from the wireless signal emitter 101 to the wireless signal receiver 103. After receiving the wireless signal WS, the wireless signal receiver 103 restores the first moving data packet 11 to the first mouse moving data 1141 and then transmits the first mouse moving data 1141 to the computer system 104. As shown in FIG. 2A, a set of moving data packet is generated for each time interval T. The time interval T is for example 8 milliseconds. That is, a wireless transmission is done per 8 milliseconds. Since the time interval T shown in FIG. 2B is also 8 milliseconds, the transmitting side (i.e. the wireless signal emitter side) performs a wireless transmission per 8 milliseconds and the receiving side transmits a set of mouse moving data to the computer system. Like the first moving data packet 11, the second moving data packet 12, the third moving data packet 13 and the fourth moving data packet 14 as shown in FIG. 2A are converted into a second moving data packet 1241, a third moving data packet 1341 and a fourth moving data packet 1441, respectively. After receiving the wireless signal WS, the wireless signal receiver 103 transmits these mouse moving data 1241, 1341 and 1441 to the computer system 104. By reading these mouse moving data, the computer system 104 can execute functions corresponding to the triggering operations of the wireless mouse 100.

As known, the wireless mouse consumes power during each data transmission. Since the mouse moving data are transmitted at predetermined time intervals and the frequency of transmitting these mouse moving data is high, the wireless mouse has considerable power consumption.

Therefore, there is a need of providing a method for reducing power consumption of a wireless mouse to obviate the drawbacks encountered from the prior art.

### SUMMARY OF THE INVENTION

It is an object of the present invention to provide a method for reducing power consumption of a wireless mouse.

In accordance with an aspect of the present invention, there is provided a method for reducing power consumption of a wireless mouse. The wireless mouse includes a wireless signal emitter and a wireless signal receiver. The wireless signal receiver is connected to a computer system. In response to triggering operations by a user, the wireless mouse generates multiple sets of mouse moving data. The mouse moving data are transmitted from the wireless signal emitter to the wireless signal receiver. The method includes the following steps. Firstly, two sets of mouse moving data are combined into a single moving data packet, and the single moving data packet is transmitted to the wireless signal receiver. Then, the single moving data packet is divided into the two sets of mouse moving data, and the two sets of mouse moving data are successively transmitted to the computer system, wherein the two sets of mouse moving data are spaced at a specified wired transmission time interval. Then, next two sets of mouse moving data are combined into another single moving data packet, and the another single moving data packet is transmitted to the wireless signal receiver. The single moving data packet and the another single moving data packet are spaced at a specified wireless transmission time interval. The wireless transmission time interval is longer than the wired transmission time interval. The wireless transmission time interval is an integer multiple of the wired transmission time interval.

In an embodiment, the wireless signal receiver is connected to the computer system through a universal serial bus (USB).

In an embodiment, the wired transmission time interval is 8 milliseconds when the universal serial bus is operated in a low-speed mode, and the wired transmission time interval is 1 millisecond when the universal serial bus is operated in a full-speed mode.

In an embodiment, the mouse moving data include horizontal mouse moving data, vertical mouse moving data, key clicking data, scroll wheel rotating data and window horizontal scrolling data.

In accordance with another aspect of the present invention, there is provided a wireless mouse with reduced power consumption. The wireless mouse includes a mouse body, a sensor, a wireless signal emitter, a first control unit and a wireless signal receiver. The sensor is disposed within the mouse body for generating multiple sets of mouse moving data in response to triggering operations by a user. The wireless signal emitter is disposed within the mouse body for emitting a wireless signal. The first control unit is electrically connected to the wireless signal emitter for combining any two sets of mouse moving data into a single moving data packet such that the single moving data packet is transmitted with the wireless signal. Every two adjacent single moving data packets are spaced at a specified wireless transmission time interval. The wireless signal receiver connected to a computer system for receiving the wireless signal, and includes a second control unit communicated with the wireless signal emitter for dividing the single moving data packet into the two sets of mouse moving data and successively transmitting the two sets of mouse moving data to the computer system. The two sets of mouse moving data are spaced at a specified wired transmission time interval. The wireless transmission time interval is longer than the wired transmission time interval. The wireless transmission time interval is an integer multiple of the wired transmission time interval.

In an embodiment, the wireless signal receiver is connected to the computer system through a universal serial bus (USB).

In an embodiment, the wired transmission time interval is 8 milliseconds when the universal serial bus is operated in a low-speed mode, and the wired transmission time interval is 1 millisecond when the universal serial bus is operated in a full-speed mode.

In an embodiment, the mouse moving data include horizontal mouse moving data, vertical mouse moving data, key clicking data, scroll wheel rotating data and window horizontal scrolling data.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating wireless communication of a conventional wireless mouse;

FIG. 2A is a schematic timing waveform diagram illustrating related moving data packets transmitted from the wireless signal emitter of the conventional wireless mouse to the wireless signal receiver;

FIG. 2B is a schematic timing waveform diagram illustrating related mouse moving data transmitted from the wireless signal receiver to the computer system;

FIG. 3 is a schematic diagram illustrating wireless communication of a wireless mouse according to a preferred embodiment of the present invention;

FIG. 4A is a schematic timing waveform diagram illustrating related mouse moving data of the wireless mouse according to a preferred embodiment of the present invention;

FIG. 4B is a schematic timing waveform diagram illustrating related moving data packets transmitted from the wireless signal emitter of the conventional wireless mouse to the wireless signal receiver according to the present invention; and

FIG. 4C is a schematic timing waveform diagram illustrating related mouse moving data transmitted from the wireless signal receiver to the computer system according to the present invention.

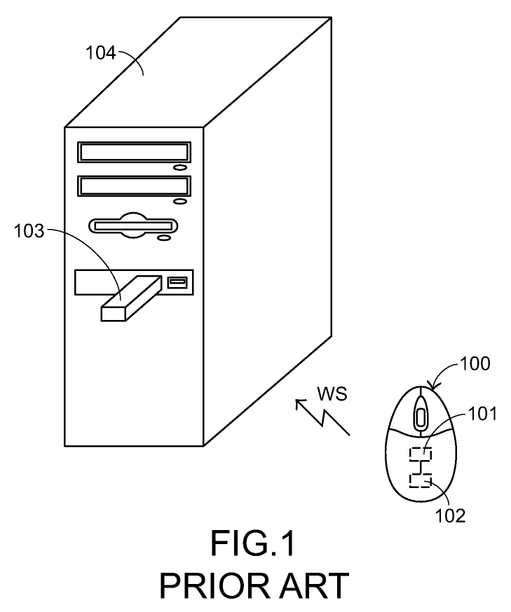

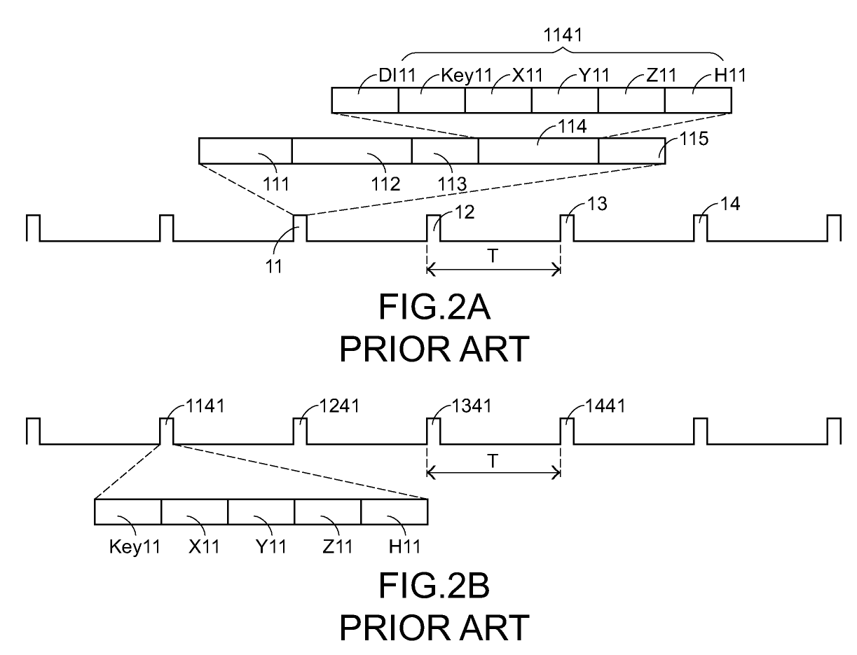

### DETAILED DESCRIPTION OF THE PREFERRED EMBODIMENT

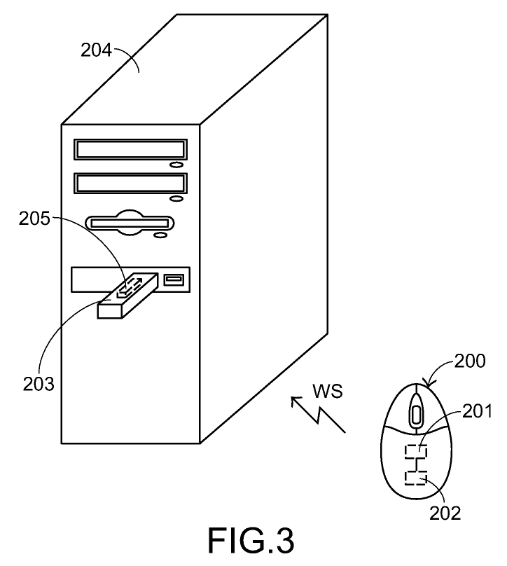

FIG. 3 is a schematic diagram illustrating wireless communication of a wireless mouse according to a preferred embodiment of the present invention. The wireless mouse 200 principally comprises a wireless signal emitter 201 and a first control unit 202. In response to triggering operations by a user, the sensor may generate multiple sets of mouse moving data. The wireless mouse 200 further includes a sensor (not shown) within the mouse body. The wireless signal emitter 201 can emit a wireless signal WS. A wireless signal receiver 203 is plugged into a universal serial bus (USB) port of the computer system 204 for receiving the wireless signal WS. The wireless signal receiver 203 is electrically connected to a second control unit 205. The hardware components of the wireless mouse 200 are substantially identical to those of the conventional wireless mouse 100, and are not redundantly described herein. In this embodiment, the wireless transmission settings and operations of the first control unit 202 and the second control unit 205 are distinguished.

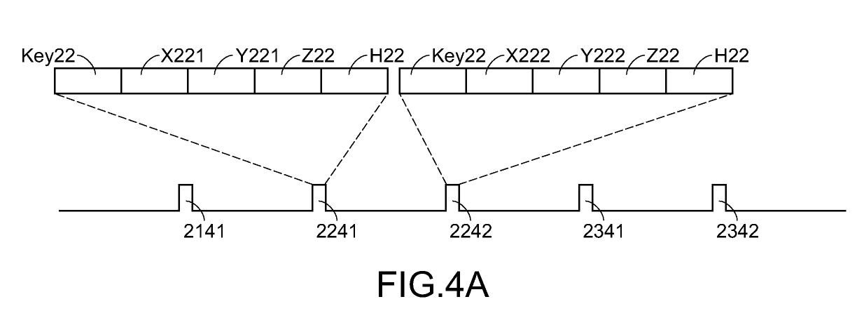

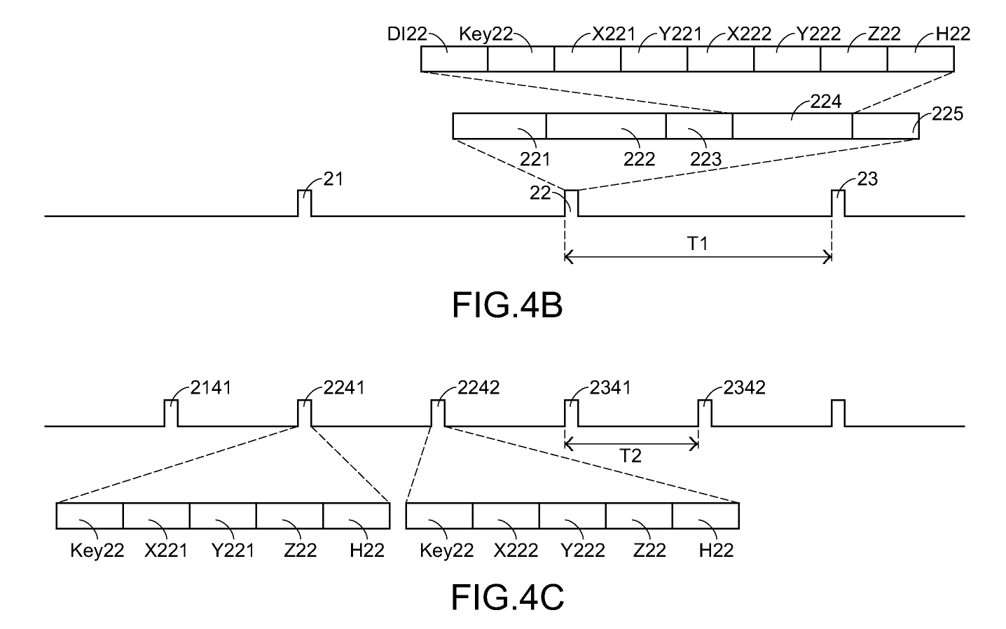

FIG. 4A is a schematic timing waveform diagram illustrating related mouse moving data of the wireless mouse according to a preferred embodiment of the present invention. In response to a triggering operation on a wireless mouse in a static status, a first mouse moving data 2141 is issued from the wireless mouse. When the user continuously operates the wireless mouse, multiple successive sets of mouse moving data including a second mouse moving data 2241, a third mouse moving data 2242, a fourth mouse moving data 2341 and a fifth mouse moving data 2342. These mouse moving data contain data formats. Take the second mouse moving data 2241 and the third mouse moving data 2242 for example. The second mouse moving data 2241 includes a second key clicking data Key22, a second horizontal mouse moving data X221, a second vertical mouse moving data Y221, a second scroll wheel rotating data Z22 and a second window horizontal scrolling data H22. The third mouse moving data 2242 includes a second key clicking data Key22, a third horizontal mouse moving data X222, a third vertical mouse moving data Y222, a second scroll wheel rotating data Z22 and a second window horizontal scrolling data H22.

In accordance with a key feature of the present invention, multiple sets (e.g. N sets) of mouse moving data are combined into a single packet to be transmitted to the wireless signal receiver. After receiving the wireless signal WS, the wireless signal receiver restores the combined packet into the original multiple sets of mouse moving data. Then, the mouse moving data are transmitted from the wireless signal receiver to the computer system for N times. Since the amount of mouse moving data to be transmitted for each time is increased, the times required for data transmission are reduced. Under this circumstance, the power consumption of operating the wireless mouse is reduced.

FIG. 4B is a schematic timing waveform diagram illustrating related moving data packets transmitted from the wireless signal emitter of the conventional wireless mouse to the wireless signal receiver according to the present invention. FIG. 4C is a schematic timing waveform diagram illustrating related mouse moving data transmitted from the wireless signal receiver to the computer system according to the present invention. Hereinafter, the procedure of data transmission will be illustrated with reference to FIG. 3, FIG. 4B and FIG. 4C.

When the user moves the wireless mouse 200 for the first time, the wireless mouse 200 will generate a first mouse moving data 2141 (as shown in FIG. 4A). Under control of the first control unit 202, the first mouse moving data 2141 is converted into a first moving data packet 21. The data formats of the first mouse moving data 2141 and the first moving data packet 21 are identical to those of the mouse moving data and the moving data packet in the prior art, and are not redundantly described herein. In this embodiment, the first mouse moving data 2141 denotes the mouse moving data generated when the wireless mouse 200 is switched from the static status to the use status. For enhancing sensitivity of the wireless mouse 200, the first mouse moving data 2141 is directly transmitted to the wireless signal receiver 203 without accumulation. Since the mouse moving data generated when the wireless mouse 200 is switched from the static status to the use status is directly outputted, the operation of the wireless mouse 200 does not feel sluggish. In this embodiment, the first mouse moving data 2141 is directly outputted. In other word, the first mouse moving data 2141 is not combined with the next mouse moving data into the same data packet. From the second mouse moving data 2241, at least two mouse moving data are combined into a single data packet for each transmission.

After the first moving data packet 21 corresponding to the first mouse moving data 2141 is wirelessly transmitted to the wireless signal receiver 203, the first moving data packet 21 is converted into the original first mouse moving data 2141 under control of the second control unit 205. Next, the first mouse moving data 2141 is transmitted to the computer system 204. In response to successive triggering operations by the use, the second mouse moving data 2241 and the third mouse moving data 2242 as shown in FIG. 4A are generated. Except for the horizontal mouse moving data and the vertical mouse moving data, the data values included in the second mouse moving data 2241 and the third mouse moving data 2242 are substantially identical. The horizontal mouse moving data and the vertical mouse moving data indicate movement in the horizontal direction and the vertical direction, respectively.

In an embodiment, two sets of mouse moving data are transmitted for each time. When the wireless mouse 200 is operated in a low-speed mode, the time interval T1 during wireless transmission from the wireless mouse to the wireless signal receiver is 16 milliseconds. Whereas, the time interval T2 during wired transmission from the wireless signal receiver to the computer system is 8 milliseconds.

When the second mouse moving data 2241 is generated, the second mouse moving data 2241 is not converted into a data packet under control of the first control unit 202. When the third mouse moving data 2242 is generated, the second mouse moving data 2241 and the third mouse moving data 2242 are combined into a single second moving data packet 22 under control of the first control unit 202. The second moving data packet 22 includes a second pilot code 221, a second device ID code 222, a second flag 223, a second payload data 224 and a second CRC code 225. The second payload data 224 includes a second data type code D122, a second key clicking data Key22, a second horizontal mouse moving data X221, a second vertical mouse moving data Y221, a second scroll wheel rotating data Z22 and a second window horizontal scrolling data H22.

As shown in FIG. 4B, the second moving data packet 22 includes the second mouse moving data 2241 and the third mouse moving data 2242. After the first moving data packet 21 has been transmitted for 16 milliseconds, the wireless signal WS containing the second moving data packet 22 is transmitted to the wireless signal receiver 203. After the second moving data packet 22 is received by the wireless signal receiver 203, the second moving data packet 22 is divided into the original second mouse moving data 2241 and the original third mouse moving data 2242 under control of the second control unit 205. Next, the second mouse moving data 2241 and the third mouse moving data 2242 are transmitted to the computer system 204 in batches at a frequency of one time per 8 milliseconds.

Please refer to FIG. 4A again. After the fourth mouse moving data 2341 is generated, the fourth mouse moving data 2341 is not converted into a data packet under control of the first control unit 202. When the fifth mouse moving data 2342 is generated, the fourth mouse moving data 2341 and the fifth mouse moving data 2342 are combined into a single third moving data packet 23 under control of the first control unit 202, as can be seen in FIG. 4B. After the third moving data packet 23 is received by the wireless signal receiver 203, the third moving data packet 23 is divided into the original fourth mouse moving data 2341 and the original fifth mouse moving data 2342 under control of the second control unit 205. Next, the fourth mouse moving data 2341 and the fifth mouse moving data 2342 are transmitted to the computer system 204. The rest may be deduced by analogy.

The above embodiments are illustrated by referring to a wireless mouse operated in a low-speed mode. Nevertheless, the wireless mouse can be operated in a full-speed mode. In the full-speed mode, the time interval T2 during wired transmission can be reduced to 1 millisecond. In addition, ten sets of mouse moving data are transmitted for each time. In practice, at most 32 sets of mouse moving data can be combined into a single data packet for transmission.

As previously described in the conventional wireless transmission technique, all mouse moving data are converted into respective packets and a wireless transmission is done per 8 milliseconds. That is, the wireless mouse consumes electricity per 8 milliseconds. According to the present invention, after multiple successive sets of mouse moving data are accumulated and combined into a single packet, this single packet containing multiple sets of mouse moving data is transmitted to the wireless signal receiver at a longer time interval. For example, if the single packet contains two sets of mouse moving data, a wireless transmission is done per 16 milliseconds. Since the amount of mouse moving data to be transmitted for each time is increased, the times required for data transmission are reduced. Under this circumstance, the power consumption of operating the wireless mouse is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for reducing power consumption of a wireless mouse, said wireless mouse comprising a wireless signal emitter and a wireless signal receiver, said wireless signal receiver being connected to a computer system, said wireless mouse generating multiple sets of mouse moving data in response to triggering operations by a user, said mouse moving data being transmitted from said wireless signal emitter to said wireless signal receiver, said method comprising steps of:
combining two sets of mouse moving data into a single moving data packet, and transmitting said single moving data packet to said wireless signal receiver;
dividing said single moving data packet into said two sets of mouse moving data, and successively transmitting said two sets of mouse moving data to said computer system, wherein said two sets of mouse moving data are spaced at a specified wired transmission time interval; and
combining next two sets of mouse moving data into another single moving data packet, and transmitting said another single moving data packet to said wireless signal receiver, wherein said single moving data packet and said another single moving data packet are spaced at a specified wireless transmission time interval, said wireless transmission time interval is longer than said wired transmission time interval, and said wireless transmission time interval is an integer multiple of said wired transmission time interval.

2. The method for reducing power consumption of a wireless mouse according to claim 1 wherein said wireless signal receiver is connected to said computer system through a universal serial bus (USB).

3. The method for reducing power consumption of a wireless mouse according to claim 2 wherein said wired transmission time interval is 8 milliseconds when said universal serial bus is operated in a low-speed mode, and said wired transmission time interval is 1 millisecond when said universal serial bus is operated in a full-speed mode.

4. The method for reducing power consumption of a wireless mouse according to claim 1 wherein said mouse moving data include horizontal mouse moving data, vertical mouse moving data, key clicking data, scroll wheel rotating data and window horizontal scrolling data.

5. A wireless mouse with reduced power consumption, said wireless mouse comprising:
a mouse body;
a sensor disposed within said mouse body for generating multiple sets of mouse moving data in response to triggering operations by a user;
a wireless signal emitter disposed within said mouse body for emitting a wireless signal;
a first control unit electrically connected to said wireless signal emitter for combining any two sets of mouse moving data into a single moving data packet such that said single moving data packet is transmitted with said wireless signal, wherein every two adjacent single moving data packets are spaced at a specified wireless transmission time interval; and
a wireless signal receiver connected to a computer system for receiving said wireless signal, and including a second control unit communicated with said wireless signal emitter for dividing said single moving data packet into said two sets of mouse moving data and successively transmitting said two sets of mouse moving data to said computer system, wherein said two sets of mouse moving data are spaced at a specified wired transmission time interval, said wireless transmission time interval is longer than said wired transmission time interval, and said wireless transmission time interval is an integer multiple of said wired transmission time interval.

6. The wireless mouse with reduced power consumption according to claim 5 wherein said wireless signal receiver is connected to said computer system through a universal serial bus (USB).

7. The wireless mouse with reduced power consumption according to claim 6 wherein said wired transmission time interval is 8 milliseconds when said universal serial bus is operated in a low-speed mode, and said wired transmission time interval is 1 millisecond when said universal serial bus is operated in a full-speed mode.

8. The wireless mouse with reduced power consumption according to claim 5 wherein said mouse moving data include horizontal mouse moving data, vertical mouse moving data, key clicking data, scroll wheel rotating data and window horizontal scrolling data.
